(19) United States
(12) Patent Application Publication
(10) Pub. No.: US 2016/0279853 A1
(43) Pub. Date: Sep. 29, 2016

(54) Detachable Filament Guide And Nozzle Module For 3D Printers

(71) Applicant: MICRON 3DP, Kfar Saab (IL)

(72) Inventors: Arik Bracha, Hod HaSharon (IL); Eran Gal-Or, Holon (IL)

(21) Appl. No.: 15/028,622

(22) PCT Filed: Oct. 14, 2014
(86) PCT No.: PCT/IB2014/065287

§ 371 Date: Apr. 11, 2016

(30) Foreign Application Priority Data
Oct. 21, 2013 (IL) 229012

(51) Int. Cl. B29C 47/10; B29C 67/00

(52) U.S. Cl. CPC B29C 47/1018; B29C 67/0074; B29C 67/0085; B33Y 30/00

(57) ABSTRACT

This invention relates to a filament guide and nozzle replacement method which includes a fused deposition modeling 3D printer extruder having a filament feeding mechanism, a heating block unit, a motor configured to operate the feeding mechanism, and a detachable integrated filament guide and nozzle unit module. The method comprises the steps of detaching the detachable integrated filament guide and nozzle unit module from the heating block unit to prevent disassembling the heating block unit; disconnecting the detachable integrated filament guide and nozzle unit module from the filament feeding mechanism; connecting another detachable integrated filament guide and nozzle unit module to the filament feeding mechanism; and attaching the other detachable integrated filament guide and nozzle unit module to the block unit.

### TECHNICAL FIELD

The present invention is in the field of 3D printers and more particularly guide and module nozzles for fused deposition modeling (FDM) printers.

### CROSS-REFERENCE TO RELATED PATENT APPLICATIONS

This patent application claims priority from and is related to Israeli Patent Application Serial Number 229012, filed 21 Oct. 2013.

### BACKGROUND

3D printing is a process of making a three-dimensional solid object of virtually any shape from a digital model. 3D printing is achieved using an additive process, where successive layers of material are laid down in different shapes.3D printing is also considered distinct from traditional machining techniques, which mostly rely on the removal of material by methods such as cutting or drilling (subtractive processes).

A materials printer usually performs 3D printing processes using digital technology.

Additive manufacturing takes virtual blueprints from computer aided design (CAD) or animation modeling software and “slices” them into digital cross-sections for the machine to successively use as a guideline for printing. Depending on the machine used, material or a binding material is deposited on the build bed or platform until material/binder layering is complete and the final 3D model has been “printed.”

To perform a print, the machine reads the design and lays down successive layers of liquid, powder, paper or sheet material to build the model from a series of cross sections. These layers, which correspond to the virtual cross sections from the CAD model, are joined or automatically fused to create the final shape. The primary advantage of this technique is its ability to create almost any shape or geometric feature.

Typical layer thickness is around 100 micrometers (μm), although some machines such as the Objet Connex series and 3D Systems' ProJet series can print layers as thin as 16 μm. X-Y resolution is comparable to that of laser printers. The particles (3D dots) are around 50 to 100 μm in diameter.

Construction of a model with contemporary methods can take anywhere from several hours to several days, depending on the method used and the size and complexity of the model. Additive systems can typically reduce this time to a few hours, although it varies widely depending on the type of machine used and the size and number of models being produced simultaneously.

Several different 3D printing processes have been invented since the late 1970s. The printers were originally large, expensive, and highly limited in what they could produce.

A number of additive processes are now available. They differ in the way layers are deposited to create parts and in the materials that can be used. Some methods melt or soften material to produce the layers, e.g. selective laser melting (SLM) or direct metal laser sintering (DMLS), selective laser sintering (SLS), fused deposition modeling (FDM), while others cure liquid materials using different sophisticated technologies, e.g. stereolithography (SLA). With laminated object manufacturing (LOM), thin layers are cut to shape and joined together (e.g. paper, polymer, metal).

FIG. 1 depicts schematically the main components of a fused deposition modeling (FDM) printer 100, comprising a nozzle 110 ejecting molten plastic, deposited material (modeled part) 120 and controlled movable table 130.

Fused deposition modeling (FDM) uses a plastic filament or metal wire that is wound on a coil and unreeled to supply material to an extrusion nozzle, which turns the flow on and off. The nozzle heats to melt the material and can be moved in both horizontal and vertical directions by a numerically controlled mechanism that is directly controlled by a computer-aided manufacturing (CAM) software package. The model or part is produced by extruding small beads of thermoplastic material to form layers as the material hardens immediately after extrusion from the nozzle. Stepper motors or servo motors are typically employed to move the extrusion head.

The extruder is divided into two main parts:
the feeding section that is responsible for pulling filament from a spool and push it towards the nozzle; and
the “hot-end” that is responsible for melting the filament and letting it flow through the nozzle.

The hot-end has three main parts:
the guide section that guides the filament from the feeding mechanism towards the heating block;
the heating block where the filament melts; and
a nozzle having a specific orifice diameter.

Various polymers are used, including acrylonitrile butadiene styrene (ABS), polycarbonate (PC), polylactic acid (PLA), high density polyethylene (HDPE), PC/ABS, and polyphenylsulfone (PPSU). In general the polymer is in the form of a filament, which can be fabricated from virgin resins or from post-consumer waste by recyclebots.

The most common problem with 3D printer is material being stuck inside the filament guide or the nozzle.

In existing extruders, the filament guide is mechanically connected to the feeding mechanism and the heating block is mechanically connected to the filament guide. The nozzle is mechanically connected at the bottom part of the heating block. When maintenance of the filament guide is required, it is necessary to disassemble the heating block that has electrical wires before it is possible to take apart the filament guide. This operation is complex and not practical for unprofessional users of consumer products.

In the last years, 3D printers entered the consumer market and are not anymore expensive products for just engineers and industrial designers. Just a few years ago, sales of 3D printers included service by professional technicians. However, in today's fast growing low level market, easy maintenance and repair become essential.

### SUMMARY

According to the present invention there is provided a Fused Deposition Modeling (FDM) 3D printer extruder comprising: a filament feeding mechanism; a heating block unit; a motor configured to operate the feeding mechanism; and a detachable integrated filament guide and nozzle unit module (DFGNM) configured to be removed without taking apart the heating block unit.

The DFGNM may be connected to the heating block unit.

The heating block may be rigidly and directly connected to the extruder body.

The rigid and direct connection of the heating block to the extruder body may be by a “C shaped” construction.

The rigid and direct connection of the heating block to the extruder body may be by spacers.

The filament guide and the nozzle may be connected by thread.

The filament guide and the nozzle may be connected by welding.

The filament guide may be connected to the extruder feeding mechanism by one of slide fitting and thread.

I may not be necessary to readjust the nozzle height after replacement.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 depicts schematically the main components of a fused deposition modeling (FDM) printer;

FIG. 2 is a schematic design of a 3D printer extruder according to the present invention;

FIG. 3A is a schematic design of section A-A of FIG. 2;

FIG. 3B is a schematic design of an exemplary connection between the feeding mechanism and the heating block;

FIG. 4 is a schematic design of the DFGNM 400 according to the present invention;

FIG. 5 shows side by side an exploded representation of existing hot end design and the novel hot end design; and

FIG. 6 shows the filament guide and the nozzle, which may be connected by thread or welded together.

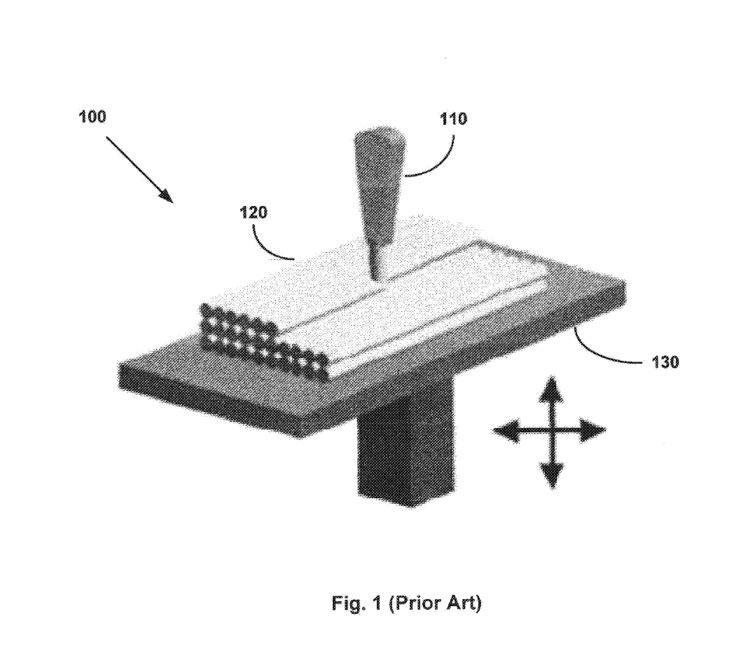

### DETAILED DESCRIPTION OF THE INVENTION

The present invention provides a new mechanical design of the most critical/important component of any FDM (Fused Deposition Modeling) 3D printer: the extruder. Unlike existing designs, the new mechanical design enables the replacement of the most critical and problematic components of the 3D printers' extruder, the filament guide and the nozzle, which constitute a single detachable module that is very easy to replace without the need to disassemble the heating block and without disconnecting any electricity wires. The module can be detached from the heating block by easy unclamping or other simple operation, and can be replaced with a new one.

In the novel mechanical design of the extruder, the hot-end is mechanically attached to the filament feeding mechanism but the filament guide and nozzle unit is detachable by simple clamp or similar mounting.

Another important feature of the design is that replacing the filament guide and the nozzle module does not change the nozzle height so that it is not necessary to readjust the nozzle height. Thus such a maintenance operation is similar to replacing an ink cartridge on inkjet printer.

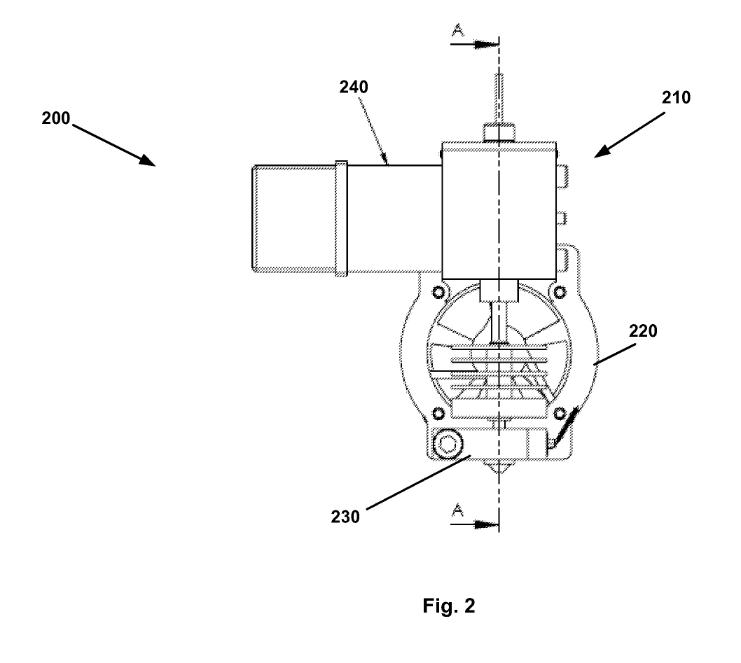

FIG. 2 is a schematic design of a 3D printer extruder 200 comprising a filament feeding mechanism 210, adapter plate 220 that connects the feeding mechanism to the heating block 230 and a motor 240.

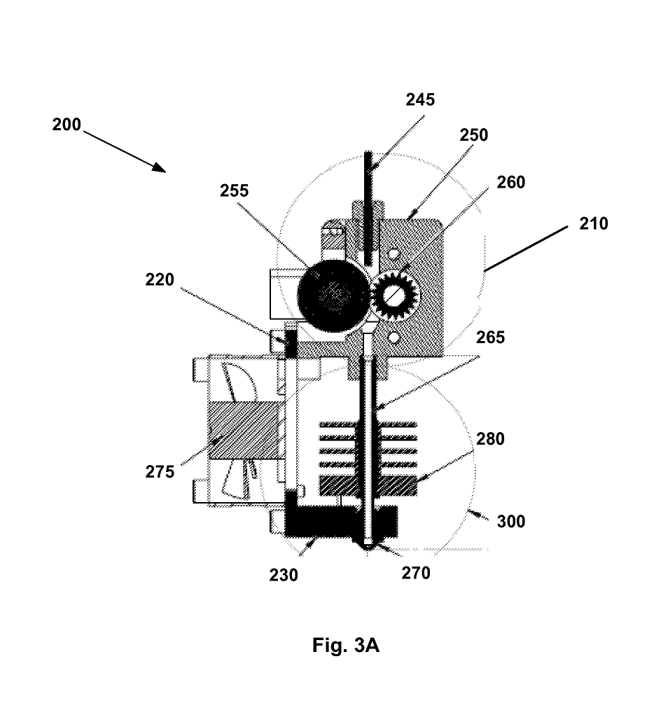

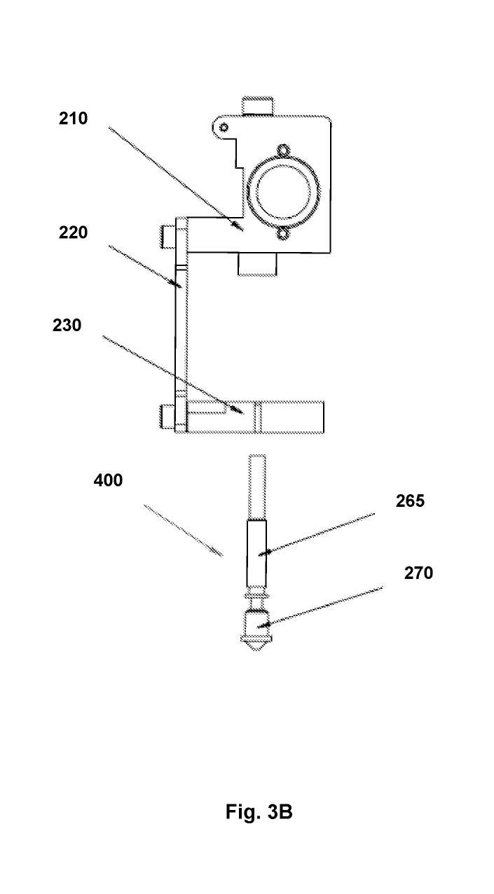

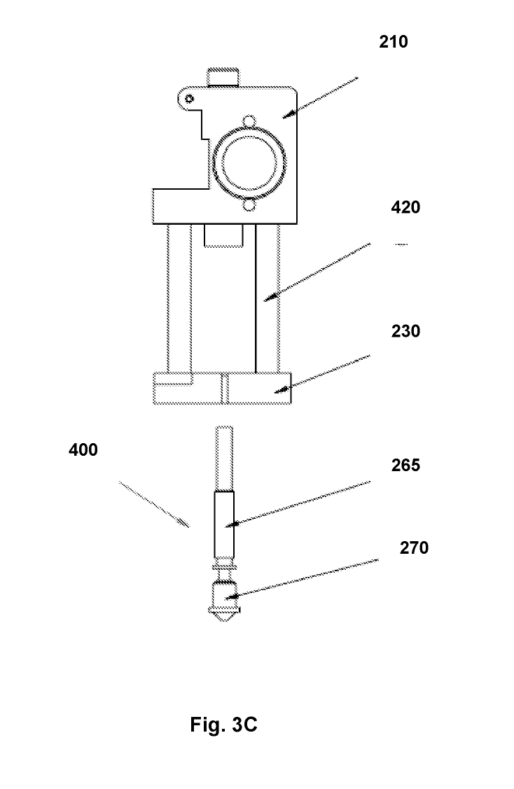

A fan 275 (FIG. 3) may optionally comprise a part of the extruder 200.

FIG. 3A is a schematic design of section A-A of FIG. 2, showing details of the extruder 200, comprising:
On top, the Extruder feeding mechanism 210 comprising:
   Filament stock 245.
   Feeding mechanism housing 250.
   Idler bearing 255.
   Hobbed gear 260.

The idler bearing 255 presses the filament towards the hobbed gear 260. The motor 240 rotates the hobbed gear that pushes the filament towards the hot end.

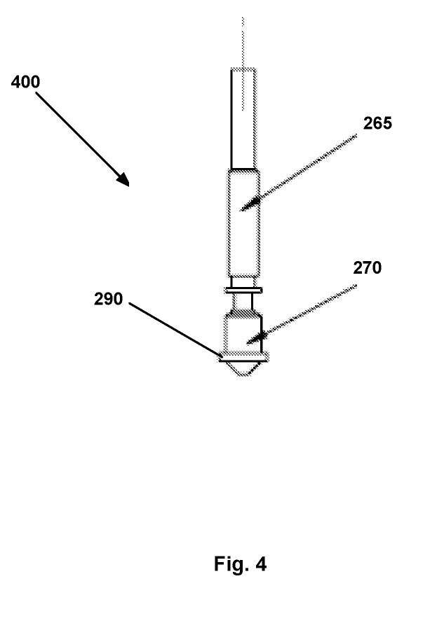

At the bottom of FIG. 3A, the hot end 300 comprising:
DFGNM (detachable integrated filament guide and nozzle unit module) 400 that is shown separately in FIG. 4 comprising filament guide 265 and nozzle 270
An optional heat sink 280 which is threaded or clamped to the guide
Optional Fan 275
Heating block 230

The filament guide 265 is connected to the extruder feeding mechanism housing 250 by slide fitting or thread, i.e. not a rigid connection, so it is possible to detach it downward.

FIG. 3B shows schematically what is titled “C shape construction” comprising the extruder feeding mechanism 210, adapter plate 220, and heating block 230. The same invention can be implemented by other connection between the feeding mechanism and the heating block. For example, as depicted schematically in FIG. 3C, spacers 420 may connect the feeding mechanism and the heating block on both sides of the guide.

In existing designs, the heating block is connected to the guide and the guide is connected to the feeding mechanism permanently so in order to take apart the guide it is necessary to take apart the heating block, which means to take apart almost the entire hot end. According to the present invention's hot end construction, there is a connection between the heating block and the feeding mechanism (as shown in FIGS. 2 and 3), enabling the removal of the DFGNM (detachable integrated filament guide and nozzle unit module) without taking apart the heating block unit.

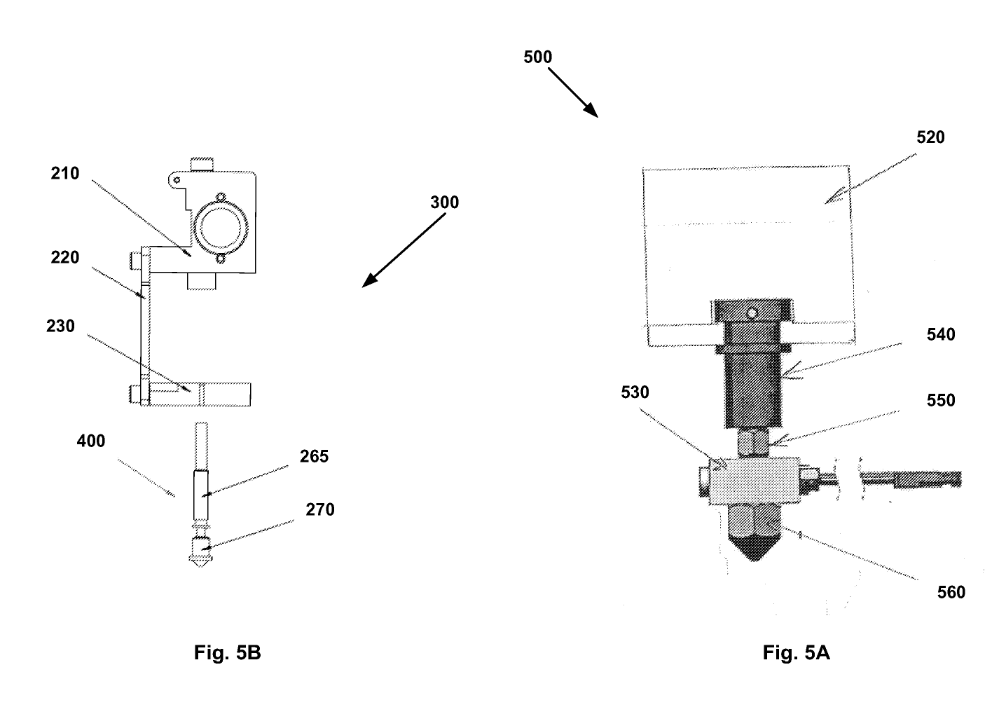

FIG. 5 shows side by side an exploded representation of existing hot end design 500 (FIG. 5A) and the novel hot end design 300 (FIG. 5B).

Existing hot end design 500 comprises:
Feeding mechanism 520
Feeding mechanism connector 540.
Filament guide 550.
Heating block 530.
Nozzle 560.

The novel hot end design 300 comprises:
Filament feeding mechanism 210
Adapter plate 220
Heating block 230

The DFGNM 400 is attached to the heating block by simple clamp or by thread.

FIG. 4 is a schematic design of the DFGNM 400 according to the present invention, comprising the filament guide 265 and the nozzle 270. On the nozzle design there is a shoulder feature 290 that is accurate relative to the nozzle exit so it is not necessary to readjust the nozzle height after replacement.

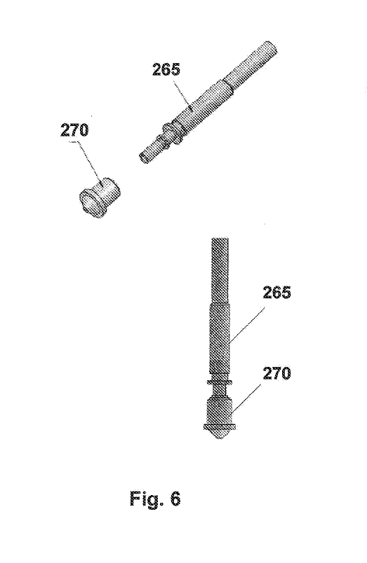

FIG. 6 shows the filament guide 265 and the nozzle 270, which may be connected by thread or welded together.

The novel extruder of the present invention is also compatible with 3D printer extruders that use glass as the deposit material (melted glass flows in the guide and the nozzle).

1. A system (1) for growing produce (3) in greenhouses, the system (1) comprising:
at least one greenhouse (5) for housing the produce (3) to be grown, the at least one greenhouse (5) being positioned, shaped and sized for receiving direct sun rays (7d) from the sun (9); and
at least one reflector assembly (11) proximate to the at least one greenhouse (5) and being positioned, shaped and sized for redirecting indirect sun rays (7i) by-passing the least one greenhouse (5), towards at least one targeted area (13) within the at least one greenhouse (5), so as to provide said at least one greenhouse (5) with assisted complementary solar energy, the at least one targeted area (13) including a plurality of different targeted areas (13) via a corresponding operation of different reflective panels (33) of the at least one reflector assembly (11).

2. A system (1) according to claim 1, wherein the at least one reflector assembly (11) comprises:
at least one erect support structure (15), separate from the at least one greenhouse (5); and
at least one reflective surface (17), operatively mountable onto the at least one erect support structure (15), for reflecting indirect sun rays (7i) towards the at least one targeted area (13) within the at least one greenhouse (5).

3. A system (1) according to claim 2, wherein the at least one erect support structure (15) is substantially perpendicular with respect to a ground surface (19).

4. A system (1) according to claim 2, wherein the at least one erect support structure (15) is substantially slanted with respect to a ground surface (19), and inclined towards the at least one greenhouse (5).

5. A system (1) according to claim 2, wherein a given side (21) of the at least one erect support structure (15) facing the at least one greenhouse (5) and the at least one reflective surface (17) are substantially coplanar.

6. A system (1) according to claim 2, wherein the at least one reflective surface (17) is inclined at an operative angle (θ) with respect to a vertical plane (23) so as to redirect sun rays (7) towards the at least one targeted area (13) within the at least one greenhouse (5) at a given effective angle (Φ).

7. A system (1) according to claim 6, wherein the operative angle (θ) of the at least one reflective surface (17) ranges between about 30 degrees and about 40 degrees with respect to the vertical plane (23).

8. A system (1) according to claim 6, wherein the effective angle (Φ) ranges between about 0 degrees and about 90 degrees.

9. A system (1) according to claim 2, wherein the at least one reflective surface (17) is displaceable along at least one degree of freedom with respect to the at least one erect support structure (15) in order to redirect sun rays (7) into the at least one greenhouse (5) at optimal angles.

10. A system (1) according to claim 2, wherein the at least one erect support structure (15) includes a solid structure.

11. A system (1) according to claim 2, wherein the at least one erect support structure (15) includes a truss structure.

12. A system (1) according to claim 2, wherein the at least one erect support structure (15) is mountable onto a base (25), and wherein the at least one erect support structure (15) is moveable along at least one degree of freedom with respect to said base (25).

13. A system (1) according to claim 2, wherein the at least one erect support structure (15) is moveable in relation to a movement of the sun (9).

14. A system (1) according to claim 12, wherein the base (25) is moveable along at least one degree of freedom with respect to a ground surface (19).

15. A system (1) according to claim 14, wherein the base (25) is moveable in relation to a movement of the sun (9).

16. A system (1) according to claim 2, wherein the at least one reflective surface (17) is positioned on a northern side of the at least one greenhouse (15).

17. A system (1) according to claim 2, wherein the at least one reflective surface (17) faces southward.

18. A system (1) according to claim 2, wherein the at least one reflective surface (17) has a height (27) dimensioned in view of at least one parameter selected from the group consisting of a) a width (W) of the at least one greenhouse (5); b) a desired light penetration angle; c) a height (H) of a side of the at least one greenhouse (5); and d) limitations imposed by local by-laws.

19. A system (1) according to claim 2, wherein the at least one reflective surface (17) has a length (29) being substantially equal to a length (L) of the at least one greenhouse (5).

20. A system (1) according to claim 2, wherein the at least one reflective surface (17) has a length (29) dimensioned in view of a side orientation of the sun (9).

21. A system (1) according to claim 2, wherein the at least one reflective surface (17) has a length (29) dimensioned in view of a correction factor for misalignment of the at least one greenhouse (5).

22. A system (1) according to claim 2, wherein the at least one reflective surface (17) includes at least one row (31) of reflective panels (33) extending along a length (29) of said at least one reflective surface (17).

23. A system (1) according to claim 22, wherein the at least one row (31) of reflective panels (33) are parallel to a north-facing wall of the at least one greenhouse (5).

24. A system (1) according to claim 22, wherein the reflective panels (33) are operatively mountable to the at least one erect support structure (15), and are moveable via an actuating mechanism (35) along at least one degree of freedom with respect to said at least one erect support structure (15).

25. A system (1) according to claim 24, wherein the actuating mechanism (35) includes at least one servo-motor.

26. A system (1) according to claim 22, wherein the reflective panels (33) are independently actuated with respect to each another.

27. A system (1) according to claim 22, wherein the reflective panels (33) are dependently actuated with respect to each another.

28. A system (1) according to claim 22, wherein the reflective panels (33) are synchronously actuated with respect to each another.

29. A system (1) according to claim 22, wherein the reflective panels (33) are operatively tiltable with respect to the at least one erect support structure (15) via a corresponding axle (37).

30. A system (1) according to claim 22, wherein a lowermost row (31) of reflective panels (33) is located higher than a given height of the produce (3) to be grown inside the at least one greenhouse (5).

31. A system (1) according to claim 22, wherein the reflective panels (33) are selected from the group consisting of flat panels, folded panels, curved panels, concave panels and convex panels.

32. A system (1) according to claim 22, wherein the reflective panels (33) are moveable in relation to a movement of the sun.

33. A system (1) according to claim 22, wherein the system comprises a sun-tracker (39) for tracking a movement of the sun (9), and wherein reflective panels (33) of the at least one reflector assembly (11) are operatively actuated based on signals received from the sun-tracker (39).

34. A system (1) according to claim 33, wherein the at least one erect support structure (15) is selectively orientated based on signals received from the sun-tracker (39).

35. A system (1) according to claim 1, wherein the at least one targeted area (13) includes at least one roof area (41) of the at least one greenhouse (5).

36. A system (1) according to claim 1, wherein the at least one targeted area (13) includes at least one floor area (43) of the at least one greenhouse (5).

37. A system (1) according to claim 1, wherein the at least one targeted area (13) includes at least one wall area (45) of the at least one greenhouse (5).

38. A system (1) according to claim 1, wherein the at least one targeted area (13) includes at least one intermediate area (47) of the at least one greenhouse (5).

39. A system (1) according to claim 1, wherein the at least one targeted area (13) is variable in size via an operation of the at least one reflector assembly (11).

40. A system (1) according to claim 1, wherein the at least one targeted area (13) is variable in location via an operation of the at least one reflector assembly (11).

41. A system (1) according to claim 1, wherein the at least one targeted area (13) is variable in shape via an operation of the at least one reflector assembly (11).

42. A system (1) according to claim 1, wherein the at least one greenhouse (5) comprises a roof (49) configured for allowing indirect sun rays (7i) redirected from the at least one reflector assembly (11) to penetrate through said roof (49).

43. A system (1) according to claim 42, wherein the roof (49) is made of a material selected from the group consisting of a translucid material, a translucent material, a transparent material and a perforated material.

44. A system (1) according to claim 1, wherein the at least one greenhouse (5) is oriented along an east-west axis.

45. A system (1) according to claim 1, wherein an interior portion of a northern upright wall (51) of the least one greenhouse (5) is provided with a reflective material (53) to reflect sun rays back into the at least one greenhouse (5).

46. A system (1) according to claim 1, wherein a given portion of a southern upright wall (55) of the at least one greenhouse (5) is made of a material (57) for configured for allowing sun rays to penetrate therethough, and into the at least one greenhouse (5).

47. A system (1) according to claim 46, wherein the material (57) of the given portion of the southern upright wall (55) is selected from the group consisting of a translucid material, a translucent material, a transparent material and a perforated material.

48. A kit with components for assembling a system (1) according to claim 1, in order to grow produce inside at least one greenhouse (5), the kit comprising at least one reflector assembly (11) configured to be proximate to the at least one greenhouse (5) and being positioned, shaped and sized for redirecting indirect sun rays (7i) by-passing the least one greenhouse (5), towards at least one targeted area (13) within the at least one greenhouse (5), so as to provide said at least one greenhouse (5) with assisted complementary solar energy, the at least one targeted area (13) including a plurality of different targeted areas (13) via a corresponding operation of different reflective panels (33) of the at least one reflector assembly (11).

49. A farm (59) being provided with a system (1) according to claim 1.
